(19) United States
(12) Patent Application Publication
(10) Pub. No.: US 2006/0016457 A1
(43) Pub. Date: Jan. 26, 2006

(54) Dental tape

(76) Inventor: William A. Hoffman III, Ridgewood, NJ (US)

Correspondence Address: Frank Cozzarelli, Jr. Esquire;Cozzarelli Law Firm, P.A., 727 Joralemon Street, Belleville, NJ, 07109, US

(21) Appl. No.: 10/898,083

(22) Filed: Jul. 23, 2004

(51) Int. Cl. A61C 15/00

(52) U.S. Cl. 132/321

(57) ABSTRACT

A novel dental tape having length, width, edges, and two sides for removing plaque and debris from teeth made of polymeric material having edge-frequency increasing perforation(s) through the dental tape wherein plaque and debris intercepted by said edge-frequency perforation in the dental tape are removed.

### FIELD OF THE INVENTION

The present invention relates to an improved dental tape which is easy to use and provides effective removal capability of plaque and other solids from teeth of humans.

### BACKGROUND OF THE INVENTION

Dental floss and tape are used to remove food particles, materia alba, and bacterial-plaque from interproximal surfaces of teeth. Plaque is the name given to a bacterial substance that begins as an invisible film of micro-organisms, and with saliva and foods, particularly sugars, forms a soft sticky white film on the surfaces of teeth and between teeth. If plaque is not removed daily it can develop and harden into a firmly attached substance called calculus or tartar which may cause gums to redden and swell in a condition known as gingivitis. This disease is often characterized by receding gums which causes the creation of small pockets around the teeth which trap food particles and bacteria. These pockets can enlarge if the gums become further inflamed or infected causing the bone supporting the teeth to become infected and destroyed. The weakened tissue is infection-prone and once so injured the gums cannot protect the underlying bone from the spread of this disease. Additionally, bacterial plaque produces noxious chemicals which cause cavities and irritate the gums. This is the manner in which teeth become loosened and ultimately lost, the latter stages here-described being periodontal disease.

Brushing, water jets, and toothpicks are used for cleaning teeth, but none of these are effective in removing plaque interproximally. Toothpicks are too thick and cumbersome to probe and scrape between two closely adjacent teeth surfaces. Dental floss, often a strand of multi-filament, such as nylon, is moved in a reciprocating action into the space between the sides of two teeth is somewhat effective. The unwaxed version of dental floss is less smooth and thus more abrasive and more effective in scraping plaque off the tooth enamel surfaces in question. The floss is maneuvered preferably just under the edge of the gum, held firmly against and wrapped partially around the proximal surface of the tooth and pulled over its surface toward the chewing edge.

For effective plaque removal, however, the tape or floss movement recommended has been one in a gingival-occluso direction (strigil motion) even though the movement is inconvenient and difficult for many people.

The more conventional and natural movement of the tape or floss, buccal-lingual (saw motion), has been highlighted as generally ineffective, but since it arises from the usual method for introducing the floss or tape to the interproximal surfaces, it is likely to continue to be at least a part of the typical cleaning regimen.

The effectiveness of the mechanical function of floss or tape to remove plaque—distinguished from effectiveness imparted by such included or formulated components as dentifrice, flavorings, wax and the like—is dependent on the “edge-density” or “edge-frequency”, by which I mean the edge-length per unit length of “strand” (floss or tape). In this regard, monofilament floss has an edge density of 1, while the edge density of a tape is 2. Multifilament strands would be considered to have edge-densities greater than 2. Extending this description, none of the existing basic constructions have transverse or laterally-disposed edge densities greater than 0, which explains their inefficiency in the saw motion. It is worth noting that wax coating may reduce effective edge density even in the preferred strigil motion, accounting for the widely held view that waxed strands are inefficient at plaque removal.

A high edge density may be obtained by adding material to a tape or floss, as was described by Cerceo et al. in U.S. Pat. No. 4,450,849. Such a construction entails additional material for the solid protuberances and manufacturing effort. They also describe indenting tape to create a pattern of protrusions on the side opposite. The indentations were described as carriers of debris, and did not provide new edges on the indented side and created expanded surfaces opposite only as protuberances. That is, there were no penetrations of the tape. Thus, no new edges were made. Cerceo described perforations for tear-off of a length of tape but these do not remain in the usable tape and do not contribute to cleaning in any sense. Obviously, the ends of the tape that were torn off are held in the hands of the individual doing the cleaning of the teeth. The purpose of these perforations was to form a tear-off place for the tape.

Use of dental tape and floss to remove particles and to remove plaque are separate as mentioned above. Still a different purpose is to polish dental surfaces. In these cases, the art includes tapes, flosses and complex structures with polishing ingredients compounded into the tape; however, it is also recognizable that the motions carried out with tapes and flosses would wipe a pre-deposited dentifrice from the tooth surface, or “starve” the tape/dental interface of the dentifrice, rather than conveying it and enabling it to function.

Although the present invention does not limit itself to any particular means of manufacture, in general, polymeric dental tape is usually prepared by an extrusion process controlling dimension by a variety of modalities known in the art. Thus, small dies may lead to single strands, large dies may be employed with downstream slitting, and the strands may or may not be elongated or oriented by drawing, wherein drawing has its own set of variables and may be conducted in the cold, or at or near a plurality of transition temperatures. Without mentioning fibrous dental cleaning products, nylon and other polyamides, polyesters and polyolefins have each been used for dental floss and tape.

Regardless of the method or material, a tape extruded from a die will have two edges and an edge density of 2 as covered herein above. It is recognized that with certain polymers, high draw-ratio orientations may lead to easily induced splitting lengthwise and should this occur, the edge density would be greater than 2 but transverse edges would remain “0”, zero.

One object of the present invention is to provide a dental tape with improved inherent plaque-removing capability compared to traditional dental tape or floss. Another object of the present invention is to provide a tape which is more efficient in use, allowing both gingival-occluso (strigil) motion and buccal-lingual (saw) motion to remove plaque. Another object is to provide a construction that enables user-applied pre-deposited dentifrice to be conveyed interproximally. Still another object is to provide an economical dental tape with improved edge density in both transverse and longitudinal directions. Still another object is to provide a tape having pre-deposited dentifrice, flavoring, antiseptic material, and material of a medical nature for use in treating the teeth or gums.

With the above limitations of the current technology in mind, it is an object of the present invention to provide a polymeric dental tape constructed with at least one perforation and preferably a plurality of perforations for the preferred and effective removal capability of plaque and other solids from the teeth of humans.

### SUMMARY OF THE INVENTION

I have invented a dental tape having length, width, edges, and two sides for removing plaque and debris from teeth as the tape is moved between and around teeth comprising a dental tape of polymeric material having at least one perforation through the dental tape within the active use length wherein plaque and debris riding along the dental tape sides and length and by the perforation are removed. The dental tape is unique, economical, and easily manufactured.

The present invention achieves high edge density in a dental tape by providing tapes manufactured by any commonly known method with perforations of such size, shape, location and spacing as is consistent with the underlying polymers' properties. Such perforations provide new edges, and when distinctly two-dimensional, i.e., when the perforation displaces tape material (is not simply a slit or fibrillation), the edges created can be used to scrape plaque from dental surfaces in any direction of tape motion. Such tape with perforations may be clear and unfilled or may also include various antiseptics, antibiotic materials, flavoring and other additives and can convey user-applied dentifrice and other adjuvants for dental health at the tape perforations. Mere slits in any direction are not perforations and don't create new edges. There needs to be a gap between edges and thus structure/shape.

The scale of dental tapes and holes therein is small, but the edges produced have a structure range. Various techniques may be used to achieve control of the perforations, including but not limited to, die cutting, air pulse, needle punch, laser pulse and internal formulation with gas-producing additives. Perforations thus created may range from highly regular shapes in precise positions having distinct “step” edges to “burst” structures with ragged edges and more or less random placement and size.

The size, number, structure, type and location of the perforations are determined on the basis of the material of construction's toughness and physical properties, subject to the requirement to increase edge density as defined above; further constrained by manufacturing cost. Thus, a rectangular perforation adds more edge density than a round perforation of the same area, but the corners may poorly distribute stresses and lead to early breaks. Multiple small perforations contribute more edges than single perforations of the same total area, but may lead to a tear-off line (as for postage stamps). As has been previously been noted, in U.S. Pat. No. 4,450,849 such a tear-off line is purposely generated, and the resulting perforations are not available for cleaning because those ends are held by the individual doing the cleaning; for the present invention, such tear-off perforations are undesirable and purposely avoided. Indeed, in the present invention the general limit is reached when the cross-tape polymer remaining around perforations is just sufficient to sustain the requisite strength for handling and use. Even a single perforation in about eighteen inches of tape increases the edge density and therefore the effectiveness of the tape, although, a plurality of tape perforations is more effective. The number and size of holes are limited by the decrease in tensile strength and tear resistance of each material, and not by any theory of more or less effective hole-density or hole-frequency.

General tape dimensions and material considerations have been well presented in U.S. Pat. No. 4,450,849 and are incorporated here by reference. Thus, tapes of the present invention are to be prepared from polymeric material soft enough to be tolerated by the user, in widths from about 1 mm to about 10 mm and thicknesses of about 0.5 mil to about 5 mil (0.0125 mm to about 0.125 mm).

Polymeric materials known in the art as meeting these requirements of user tolerance, strength and dimensional control can be used for the construction of the dental tape of the present invention without limiting the invention to such materials. Polymeric materials used for the dental tape, include but are not limited to polyolefins, polyesters, polyamides (nylon) and poly(tetrafluoroethylene) (Teflon®).

### DESCRIPTION OF THE PREFERRED EMBODIMENT

Dental tapes of the present invention are prepared from polymeric material soft enough to be tolerated by the user, in widths from about 1 mm to about 10 mm and thicknesses of about 0.0125 mm to 0.125 mm.

Polymeric material used for the dental tape, include but are not limited to polyolefins, polyesters, polyamides (nylon) and poly(tetrafluoroethylene) (Teflon).

There should be more than one perforation in roughly every 18 inches of length, preferably more than 18 perforations and more preferably more than 36. The inventor's hand-made tapes have about 100 perforations in 18 inches. The size of each perforation is not necessarily the same. The advantage gained by the addition of more perforations is to increase the edges—“cutting edges”—that do the cleaning work. Many small perforations add more edges than fewer larger perforations, but we come back to manufacturing process control, economics, strength loss and other random factors could dominate the actual manufacturing preferences.

The following examples illustrate embodiments of the present invention without limiting the invention thereby.

### EXAMPLE 1

A commercial polyamide dental tape of about 4 mm by 2 mil cross-section was perforated at room temperature along the centerline with a 0.25 mm hollow-needle on 1 mm spacing. Breaking strength in use was not noticeably affected, and rough measurement of breaking force (lifting weights with original vs. perforated tape) showed variation between the two to be no more than the variation of the measurement.

### EXAMPLE 2

A high-density polyethylene film was cold-drawn 5:1 to a 7 mm by 0.5 mil (0.0125 mm) thickness tape with a calculated (from material property) breaking strength of 15 lb force. Perforations made as in EXAMPLE 1 did not noticeably affect the breaking strength in use. The tape was easily inserted into close-spaced teeth, was comfortable in use, easily gripped and showed evidence of plaque in the perforations after use by examination under a microscope.

### EXAMPLE 3

A tape prepared according to EXAMPLE 2 was perforated with a heated blunt tool along the centerline from both sides of the tape, leaving perforations of 1 mm to 2 mm width and 3 mm to 5 mm length, spaced so that 3 mm intervals were left between perforations. Such perforations have new edges totaling approximately 11 mm/8 mm original tape length, of which 8 mm are parallel to the original tape edges (an increase of 50%) and 3 mm are perpendicular, thus providing edges where there were none originally. The tape was easy to use and showed evidence of plaque on all edges after use in strigil or saw motion.

### EXAMPLE 4

A tape prepared according to EXAMPLE 3 was used in a therapeutic method of cleaning teeth wherein said method combined both gingival-occlusal (“strigil”) and buccal-lingual (“saw”) motions.

Alternate embodiments of practicing the invention but within the spirit thereof, will, in light of this disclosure, occur to persons skilled in the art. It is intended that this description be taken as illustrative only and not construed in any limiting sense except by the following claims.

I claim:

1. A dental tape of polymeric material having length, width, edges, two sides, and at least one edge-frequency increasing perforation through the dental tape wherein plaque and debris intercepted by said dental tape are removed from teeth.

2. A dental tape as defined in claim 1 wherein said dental tape is fabricated of polymeric material comprising a tape of dental tape dimensions with at least one edge-frequency increasing perforation in the body of the dental tape in about eighteen inches of dental tape length.

3. A dental tape as defined in claim 1 wherein said dental tape is fabricated of polymeric material comprising a tape of dental tape dimensions with a plurality of edge-frequency increasing perforations in the body of the dental tape in about eighteen inches of dental tape length.

4. A dental tape as defined in claim 1 wherein said dental tape is fabricated of polymeric material comprising a narrow, thin polymeric film of dimensions appropriate for dental tape use in removing plaque and debris from teeth, having a plurality of edge-frequency increasing perforations for use in cleaning of teeth in both gingival-occluso (strigil) motion and buccal-lingual (saw) motion.

5. A dental tape as defined in claim 4 wherein said dental tape preferably has at least 18 and more preferably at least 36 edge-frequency increasing perforations for every 18 inches of dental tape length.

6. A dental tape as defined in claim 1 wherein said dental tape is fabricated of polymeric material wherein said dental tape dimensions are about 1 mm. to about 10 mm. cm in width and a thickness of about 0.0125 mm to about 0.125 mm (0.5 mil to about 5 mil).

7. A dental tape as defined in claim 1 wherein said edge-frequency increasing perforations are formed by, but not limited to, methods utilizing, dies, air pulses, needle punches, laser pulses and internal formulations with gas-producing additives.

8. A therapeutic method of removing plaque and debris from teeth using a dental tape of polymeric material having length, width, edges, two sides, and at least one edge-frequency increasing perforation through the dental tape wherein plaque and debris intercepted by said dental tape are removed by a combined gingival-occlusal (“strigil”) and buccal-lingual (“saw”) motions.

9. A therapeutic method of removing plaque and debris from teeth as defined in claim 8 wherein said dental tape has a plurality of edge-frequency increasing perforations in the body of the dental tape.

10. A dental tape with a plurality of edge-frequency increasing perforations made by the methods of claim 7.
